(19) United States
(12) Patent Application Publication
(10) Pub. No.: US 2023/0143778 A1
(43) Pub. Date: May 11, 2023

(54) POLYMER ELECTROLYTE AND SECONDARY BATTERIES USING THE POLYMER ELECTROLYTE

(71) Applicant: Harumichi Kariya, Bellflower, CA (US)

(72) Inventor: Harumichi Kariya, Bellflower, CA (US)

(21) Appl. No.: 17/983,269

(22) Filed: Nov. 8, 2022

Related U.S. Application Data
(60) Provisional application No. 63/278,398, filed on Nov. 11, 2021.

(51) Int. Cl. H01M 10/0565; H01M 10/0525; H01M 4/38

(52) U.S. Cl. CPC H01M 10/0565; H01M 10/0525; H01M 4/381; H01M 2004/027

(57) ABSTRACT

Aspects of the disclosure are directed to a battery, including an anode; a cathode; and an electrolyte between the anode and the cathode, wherein the electrolyte comprises at least one polymer electrolyte that includes sulfur dioxide. In one aspect, a disclosed method includes a) assembling an anode for a battery cell; b) assembling a cathode for the battery cell; c) synthesizing an electrolyte that comprises at least one polymer electrolyte with sulfur dioxide and d) integrating the assembled anode, the assembled cathode, and synthesized electrolyte to create a battery.

### CLAIM OF PRIORITY UNDER 35 U.S.C. § 119

The present Application for Patent claims priority to Provisional Application No. 63/278,398 entitled “Polymer Electrolyte and Secondary Batteries Using the Polymer Electrolyte” filed Nov. 11, 2021, and assigned to the assignee hereof and hereby expressly incorporated by reference herein.

### TECHNICAL FIELD

This disclosure relates generally to the field of batteries, and, in particular, to a battery using a polymer electrolyte.

### BACKGROUND

In energy applications, electric storage systems provide a vital role in multiple scenarios. For example, an energy storage device, such as an electrochemical battery with a plurality of battery cells, may supply electric energy to a portable or mobile platform without direct connection to the electric grid. Thus, there's a need for improvements and changes to energy storage devices (e.g., batteries) to enable longer shelf life, higher efficiency, and/or longer operating life.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a battery using a polymer electrolyte. The polymer electrolyte achieves ionic conductivity sufficient for battery use by incorporating sulfur dioxide and a salt. The salt may be a metal halide. The sulfur dioxide and salt may form a solvated complex. The sulfur dioxide may also facilitate the incorporation of a salt into a polymer. The sulfur dioxide polymer electrolyte may be used with inorganic components, such as inorganic electrolytes.

Another aspect of the disclosure provides a cathode for use with a battery with a sulfur dioxide polymer electrolyte. The cathode may include metal salts. For example, the cathode may include CuCl₂ as the active material. The cathode may include compounds that intercalate alkali or alkaline earth metals, such as metal oxides, metal phosphates and metal cyanides as the active material. The cathode may include carbon and binders.

Another aspect of the disclosure provides an anode for use with a battery with a sulfur dioxide polymer electrolyte. The anode may include a solid alkali or alkaline earth metal or an alloy of an alkali or alkaline earth metal as the active material. The anode may include compounds that intercalate alkali or alkaline earth metals, such as carbon or silicon. The anode may include carbon and binders.

Another aspect of the disclosure provides methods of assembling or integrating the anode, cathode, sulfur dioxide polymer electrolyte and secondary battery cell.

Another aspect of the disclosure provides a battery including an anode; a cathode; and an electrolyte between the anode and the cathode, wherein the electrolyte includes at least one polymer electrolyte that includes sulfur dioxide. In one example, the polymer electrolyte includes a polymer, sulfur dioxide and salt. In one example, the polymer electrolyte includes a polymer, sulfur dioxide and metal halide. In one example, the cathode includes metal salt. In one example, the cathode includes a compound that can intercalate metals. In one example, the anode includes an alkali or an alkaline earth metal. In one example, the anode includes an alkali or an alkaline earth metal. In one example, the electrolyte includes an inorganic metal-containing compound. In one example, the electrolyte includes an inorganic metal-containing compound.

Another aspect of the disclosure provides a method including a) assembling an anode for a battery cell; b) assembling a cathode for the battery cell; c) synthesizing an electrolyte that includes at least one polymer electrolyte with sulfur dioxide; and d) integrating the assembled anode, the assembled cathode, and synthesized electrolyte to create a battery. In one example, the polymer electrolyte includes a polymer, sulfur dioxide and a salt. In one example, the polymer electrolyte includes a polymer, sulfur dioxide and a metal halide. In one example, the cathode includes a metal salt. In one example, the cathode includes a compound that can intercalate metals. In one example, the anode includes an alkali or an alkaline earth metal. In one example, the anode includes an alkali or an alkaline earth metal. In one example, the electrolyte includes an inorganic metal-containing compound. In one example, the electrolyte includes an inorganic metal-containing compound.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates a first example embodiment of a secondary battery cell with a polymer electrolyte with sulfur dioxide.

FIG. 2 illustrates a second example embodiment of a secondary battery cell with a polymer electrolyte with sulfur dioxide.

FIG. 3 illustrates an example flow diagram for assembling a secondary battery with a polymer electrolyte with sulfur dioxide.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In one aspect, a battery transforms stored chemical energy into consumable electric energy to a load using a chemical reaction. In one example, a secondary (i.e., rechargeable) battery has three main constituents:
Anode—source of electrons via oxidation during discharge (i.e., loss of electrons);
Cathode—sink of electrons via reduction during discharge (i.e., gain of electrons); and
Electrolyte—interconnection (e.g., electrically insulating) between anode and cathode to allow ionic transport.

In one aspect, a battery includes two electrodes: an anode and a cathode. For example, the anode and the cathode may be porous to increase surface area. For example, the anode and the cathode may include active materials that contribute to or affect the chemical reactions within the battery. In addition, the battery may have an electrolyte to serve as a medium for charge balancing between the anode and the cathode. In one example, ionic conductivity, that is, the capability to transport ionic charges, is an important property of the electrolyte. For example, there are a variety of electrolytes that may be used in a secondary battery. For example, electrolytes may be, or have constituents that are, liquid, solid, or gel-like. For example, a liquid electrolyte may permeate both the anode and cathode. For example, a solid electrolyte may have lower permeability than a liquid electrolyte. For example, some electrolytes are susceptible to dendrite (i.e., undesired metallic whisker) growth which may result in an electrical short circuit. In one example, solid electrolytes with different properties may be employed. For example, a polymer electrolyte is one alternative.

Electrochemical batteries may be used to store energy in chemical form and to deliver energy to a load in electrical form. A primary battery delivers energy until it is depleted and thus has a limited lifetime. A secondary battery is rechargeable and delivers energy as long as it maintains sufficient electrical charge. That is, the secondary battery undergoes a plurality of charge and discharge cycles during its lifetime.

Electrolytes (i.e., interconnection between anode and cathode) for secondary batteries, such as lithium-ion batteries, are of great interest as electrification of society expands. There are different types of electrolytes used in various applications. For example, usage of flammable liquid electrolytes in lithium-ion batteries may result in an increased hazard risk as larger battery packs proliferate (e.g., batteries in electric vehicles and energy storage batteries for buildings). In one aspect, there is a growing drive to increase the energy density of secondary batteries, as electrical energy from batteries increasingly replaces other high-density energy sources such as fossil fuels. For example, a non-flammable electrolyte which enables a simple and compact metallic anode may address desirable goals of non-flammability and higher energy density, and may facilitate further electrification.

Current lithium-ion batteries use intercalation compounds to mitigate the growth of dendrites that are otherwise prone to forming at the anode. Dendrites can lead to an internal short circuit within the battery and shorten its lifespan. A metallic anode that is free of intercalation compounds allows for a more compact battery, but necessitates a means to prevent the growth of dendrites. Solid phase electrolytes may be used for this, but due to their hard and solid nature, can be difficult to make intimate contact with the anode and cathode, which affects performance and longevity. This disclosure presents a polymer electrolyte with sulfur dioxide that is non-flammable and may create good contact with the anode and cathode. The polymer electrolyte may be used with metallic anodes or with intercalation compounds at the anode. The polymer electrolyte may also be used in conjunction with solid inorganic electrolytes.

Sulfur dioxide (SO₂) is an abundant, non-flammable, inexpensive inorganic solvent. An example of an application of sulfur dioxide is in household appliances like refrigerators. Another example of an application of sulfur dioxide is the electrolyte of some lithium primary batteries, as a liquid lithium tetrachloroaluminate solvated complex (LiAlCl₄-nSO₂, where n>3). In a battery application, electrolytes based on sulfur dioxide offer benefits in high ionic conductivity (up to 0.08 Siemens/cm) and compatibility with the reactive surface of an alkali metal. That is, electrolytes based on sulfur dioxide do not chemically break down during normal operation of the battery.

Sulfur dioxide and a salt may be incorporated into a polymer such that much of the beneficial characteristics of the sulfur dioxide electrolyte are retained (e.g., ionic conductivity, compatibility with reactive metal anode) while other attributes are minimized by the polymer. For example, the incorporation of sulfur dioxide and salt imparts or enhances the ionic conductivity of the polymer. For example, the incorporation of sulfur dioxide into a polymer may mitigate its tendency to evaporate and escape from the battery cell. In one example, a polymer electrolyte may serve as an ionic conductor between the anode and cathode terminals of a battery. This polymer electrolyte with sulfur dioxide may be used like other solid phase electrolytes to block dendrites and afford a metallic anode. It may also be used as non-flammable ionic conductor within the anode or cathode structure, in conjunction with a different solid inorganic electrolyte.

In one example, a polymer electrolyte may be used in an electrochemical battery cell, fabricated by combining a sulfur dioxide solvated complex of a halogen salt (i.e., a sulfur dioxide solvated salt complex) and a compatible polymer, or by using sulfur dioxide to increase the solubility of a salt into a polymer. For example, a sulfur dioxide solvated salt complex in a polymer electrolyte may be fabricated inexpensively and is not flammable under standard operating conditions.

In one example, an electrolyte for a battery cell may be a polymer doped with a salt, where the doping is facilitated by sulfur dioxide (SO₂). For example, the doping may be performed by a sulfur dioxide solvated complex of a halogen salt (i.e., a sulfur dioxide solvated salt complex). The polymer electrolyte may be of a solid, semi-solid, or gel-like consistency, depending on the polymer used, amount of sulfur dioxide and the amount and type of halogen salt. When solid, the polymer electrolyte may be used to block dendrite growth that commonly forms on the anode, especially without intercalation compounds.

For example, the halogen salt may be any of, or a combination of the following halogen salts: LiAlX₄, LiGaX₄, Li₂CuX₄, Li₂NiX₄, Li₂ZnX₄, Li₂CoX₄, Li₂PdX₄, LiMgX₃, Li₂MnX₄ LiFeX₄, NaAlX₄, NaGaX₄, Na₂NiX₄, Na₂CuX₄, Na₂ZnX₄, Na₂CoX₄, Na₂PdX₄, NaMgX₃, Na₂MnX₄ NaFeX₄, KAlX₄, K₂CuX₄, K₂NiX₄, K₂ZnX₄, K₂CoX₄, K₂PdX₄, KMgX₃, K₂MnX₄, KFeX₄, CaAlX₅, CaAl₃X₈, CaCuX₄, CaZnX₄, CaMgX₄, Ca₂MnX₆ CaFeX₅, MgAlX₅, MgAl₃X₈, MgCuX₄, MgZnX₄, Mg₂MnX₆, MgFeX₅, where X is Cl (chlorine), Br (bromine), I (Iodine), or F (fluorine).

For example, in the sulfur dioxide solvated salt complex, the number of moles of sulfur dioxide per mole of salt, described by x in the case of NaAlCl₄ as NaAlCl₄-xSO₂, may be a value greater than 0.01 and less than 20. In one example, the sulfur dioxide solvated salt complex may range from 1% to 80% of the polymer electrolyte by weight (i.e., the remaining constituents, e.g., polymer, inorganic compounds, etc., may range from 99% to 20% by weight).

Additionally, the polymer electrolyte may include one or more additional salt, such as, but not limited to, NaCl, NaBr, NaPF₆, NaBF₄, NaF, NaI, NaFSI, NaTf, NaTFSI, NaAsF₆, NaClO₄, LiCl, LiBr, LiPF₆, LiBF₄, LiF, LiI, LiFSI, LiTf, LiTFSI, LiAsF₆, LiClO₄, KCl, KBr, KI, KF, CaCl₂, CaBr₂, CaI₂, CaF₂, MgCl₂, MgBr₂, MgI₂, MgF₂, which may be either or both soluble in the sulfur dioxide solvated salt complex or/and the polymer.

In one example, sulfur dioxide may be used to increase a salt's solubility in a polymer. That is, the polymer may include sulfur dioxide and a salt. The salt may or may not have high solubility in the sulfur dioxide. These salts may include NaCl, NaBr, NaPF₆, NaBF₄, NaF, NaI, NaFSI, NaTf, NaTFSI, NaAsF₆, NaClO₄, LiCl, LiBr, LiPF₆, LiBF₄, LiF, LiI, LiFSI, LiTf, LiTFSI, LiAsF₆, LiClO₄, KCl, KBr, KI, KF, CaCl₂, CaBr₂, CaI₂, CaF₂, MgCl₂, MgBr₂, MgI₂, MgF₂. In one example, the sulfur dioxide may range from 1% to 70% of the polymer electrolyte by weight, and the salt may range from 10% to 70% by weight.

Polymers used for the sulfur dioxide polymer electrolyte may include, but are not limited to, polyethylene oxide, polyetherimide, polyimide, polyamide (polyamide 3, 4, 5, 6, 7, 8, 9, 10, 11, 12 and copolymers, aromatic polyamides), polyamide-imides, polyphthalamide, polymethyl acrylate, polymethyl methacrylate, polyvinyl alcohol, polyvinyl chloride, polyvinyl chloride acetate, acrylonitrile butadiene styrene, polysulfone, polyethersulfone, polyphenylene sulfone, polyacrylamide, cellulose acetate/diacetate/triacetate, cellulose acetate butyrate, polyethylene terephthalate, polyvinylphenol, polylactic acid, polycarboxylic acid, polyacrylonitrile, polyvinylidene fluoride, polyurethane, polycarbonate, polypropylene carbonate, polytrimethylene carbonate, melamine and phenolic resins and their combinations. For example, many of the afore-mentioned polymers may be mass produced and may be used with little or no alteration to produce the polymer electrolyte, reducing costs over other polymer electrolytes.

For example, polymerized versions of materials used as inorganic solid electrolytes, such as sulfides, may also be used. The polymers may include anionic groups that may facilitate ionic conduction of alkali or alkaline earth cations. The anionic groups may be carboxylate (—CO₂⁻), sulfonate (—SO₃⁻), borate (—B⁻), or sulfonylimides. For example, inclusion of these anionic groups may facilitate the ionic transport of alkali or alkaline earth cations such that the transference number (i.e., ratio of electric current derived from the cation to the total electric current) is increased.

In one example, the sulfur dioxide polymer electrolyte may also include inorganic components. The inorganic components may increase the ionic conductivity of the polymer electrolyte by being ionically conducting themselves (e.g., the inorganic components are also electrolytes), or by affecting the polymer or other constituents of the polymer electrolyte to increase ionic conductivity. The inorganic components may also improve mechanical properties of the polymer electrolyte, such as the ability to block the growth of dendrites. The inorganic components may be ceramics, perovskites, anti-perovskites, argyrodites, metal oxides (e.g. beta alumina), NASICON (i.e., sodium super ionic conductor, which comprises crystalline metal oxides that include zirconium, silicon, phosphorous, sodium and oxygen) and LISICON (i.e., lithium super ionic conductor, which comprises crystalline metal oxides that include zinc, germanium, lithium and oxygen) types, garnets, metal hydrides, metal halides, metal nitrides, metal sulfides or metal phosphates and their derivatives and analogs. In one example, the inorganic components may be 1% to 80% of the polymer electrolyte by weight.

In one example, the mechanical properties of the sulfur dioxide polymer electrolyte may be affected by the selection of polymers used. Harder polymers may be used, or the addition of the sulfur dioxide solvated salt complex, or sulfur dioxide, may be controlled to increase hardness. Alternatively, polymer blends may also be used where one or more of the polymers are chosen for their properties other than their ability to accept the sulfur dioxide solvated salt complex. The polymers may or may not be miscible (i.e., homogeneous) with each other.

In one example, by using a mixture, or layers of, polymers with different mechanical characteristics and/or different levels of doping with the sulfur dioxide and salt, a polymer electrolyte with a graduated softness may be made. For example, the electrolyte may be made hard facing the anode to block dendrites but soft facing the cathode to make better contact with it. In one example, hardness may be quantified by the shear modulus.

Many cathodes in high-capacity batteries may include granular constituents or may be three-dimensional in structure, making it difficult for hard solid inorganic electrolytes (e.g., garnets, perovskites) to make intimate contact with the cathodes. Similarly, anodes may include granular constituents, or may be three-dimensional in structure. The sulfur dioxide polymer electrolyte may be made soft facing the electrode (i.e., cathode or anode) so that it may fully or partially infuse the electrode (i.e., cathode or anode) structure. The polymer electrolyte may also be fabricated within the cathode or anode structure.

In one example, the sulfur dioxide polymer electrolyte may be used in conjunction with a separate inorganic electrolyte. Such inorganic electrolyte may include, ceramics, perovskites, anti-perovskites, argyrodites, metal oxides, NASICON (i.e., sodium super ionic conductor, which comprises crystalline metal oxides that include zirconium, silicon, phosphorous, sodium and oxygen) and LISICON (i.e., lithium super ionic conductor, which comprises crystalline metal oxides that include zinc, germanium, lithium and oxygen) types, garnets, metal hydrides, metal halides, metal nitrides, metal sulfides or metal phosphates and their derivatives and analogs. In one example, the inorganic electrolyte faces the anode, and the polymer electrolyte is situated between the inorganic electrolyte and the cathode. In one example, the inorganic electrolyte faces the cathode, and the polymer electrolyte is situated between the inorganic electrolyte and the anode. In one example, two separate polymer electrolytes face the anode and cathode, and the inorganic electrolyte is situated between the two polymer electrolytes. That is, the polymer electrolytes are situated between the inorganic electrolyte and the anode and cathode.

The polymer electrolyte inside the cathode or anode may provide mechanical support for the cathode structure, preventing it from breaking under extreme conditions. For example, if a soft polymer electrolyte is used, it may accommodate the volumetric changes that may occur during charging and discharging, alleviating the stresses placed on the battery cell components. Hence, the polymer electrolyte may have two or more sections, where one may primarily serve to separate the anode and cathode, and others on either or both anode and cathode sides of it to facilitate ionic conduction.

In a secondary battery cell incorporating the polymer electrolyte with sulfur dioxide, the cathode may include conductive components such as carbon to facilitate the electrical conduction amongst the cathode constituents. The carbon may include another element such as nitrogen, oxygen, boron, phosphorous, fluorine, sulfur or silicon. The cathode may also include binders, which holds the multi-component structure together and may be of polymers such as polyvinylidene fluoride. The cathode may be interfaced with a current collector, which be made of electrically conductive material such aluminum or carbon.

In one example, the active material in the cathode may be an intermetallic, metal phosphate, metal oxide, metal hydroxides, or metal cyanides. These compounds may include nickel, manganese, cobalt, oxygen, vanadium and iron and a combination thereof. For example, the cathode may contain QNiₓCo_{y}Al_{z}O₂ (where Q is lithium or sodium and x+y+z=1), QNiₓMn_{y}Co_{z}O₂ (where Q is lithium or sodium and x+y+z approximately equals 1), QₓMn_{y}O_{z} (where Q is lithium or sodium x=1 to 2, y=1 to 2, and z=2 to 4), QFePO₄ (where Q is lithium or sodium), QCoO₂ (where Q is lithium or sodium), QₓM_{y}[G(CN₆)]_{z} (where Q is lithium or sodium, M and G are transition metals, x=0 to 3, y=1 to 5, and z=1 to 5) or QₓV_{y}O_{z} (where Q is lithium or sodium and x=0 to 5, y=1 to 5 and z=1 to 7).

In one example, the cathode may include metal halides, such as metal chlorides, metal bromides, metal fluorides, and/or metal iodides as the active material. Examples of metal halides that may be included in the cathode are: CuX, CuX₂, NiX₂, FeX₂, FeX₃ ZnX₂, MnX₂, CrX₂, CrX₃, MoX₃, where X may be a chloride (Cl), a bromide (Br) fluoride (F), or iodide (I). One or more of the metal halides may be used in a single cell. The metal associated with the metal halide (e.g., Cu, Ni, Fe, Zn, Mn, Cr, Mo) may also be included in the cathode. The metal associated with the metal halide may be covered with the associated metal halide (e.g copper covered with copper chloride). The current collector of the cathode may include the metal associated with the metal halide.

In another example, the cathode may include metal polysulfides and sulfur as the active material. The metal polysulfides may include sodium, lithium, potassium, magnesium or calcium, and may include any of the following: Na₂Sₙ, Li₂Sₙ, K₂Sₙ, MgSₙ, CaSₙ where n may be any integer value between 1 and 8.

In another example, the cathode may include (a) bismuth selenide or bismuth teluride, (b) transition metal dichalcogenide or trichalcogenide, c) sulfide, selenide, or teluride of niobium, zirconium, molybdenum, hafnium, tantalum, tungsten, titanium, cobalt, manganese, iron, nickel, or a transition metal; (d) boron nitride, or (e) a combination thereof as the active material. In one example, the content of the active material in the cathode may be 50 to 99% by weight.

In a battery cell incorporating the polymer electrolyte with sulfur dioxide, the anode may include conductive components such as carbon to facilitate the electrical conduction amongst the anode constituents. The carbon may include another element such as nitrogen, oxygen, boron, phosphorous, fluorine, sulfur or silicon. The anode may also include binders, which holds the multi-component structure together and may be of polymers such as polyvinylidene fluoride. The anode may be interfaced with a current collector, which be made of electrically conductive material such copper or carbon.

In one example, the anode may include a solid alkali or alkaline earth metal, such as lithium, sodium, magnesium, potassium or calcium or an alloy of these metals as the active material. The anode may also include one or more of: (a) silicon (Si), germanium (Ge), tin (Sn), lead (Pb), antimony (Sb), bismuth (Bi), Zinc (Zn), boron (B), indium (In), aluminum (Al), nickel (Ni), cobalt (Co), manganese (Mn), titanium (Ti), iron (Fe) and cadmium (Cd), (b) stoichiometric and non-stoichiometric alloys or intermetalic compounds of Si, Ge, Sn, Pb, Sb, Bi, B, In, Zn, Al, or Cd with other elements, (c) oxides, carbides, nitrides, sulfides, phosphides, selenides, and telurides of Si, Ge, Sn, Pb, Sb, Bi, B, In, Zn, Al, Fe, Ni, Co, Ti, Mn, or Cd, and their mixtures or composites; (d) salts and hydroxides of Sn; and combinations thereof.

In one example, the anode may include intercalating compounds as the active material. The intercalating compound may be a structure with carbon, silicon, aluminum, tin, metal oxides, metal cyanides or other intermetallic compound. In one example, the content of the active material in the anode may be 50 to 100% by weight.

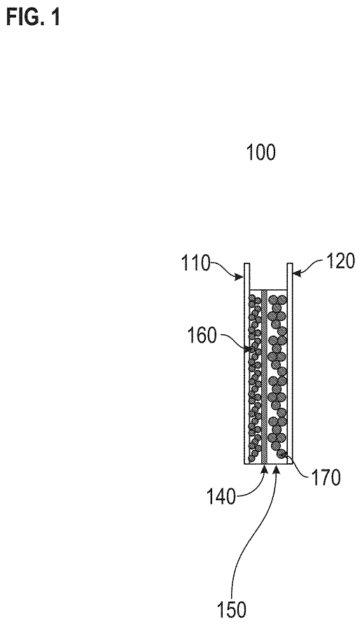

In one example, FIG. 1 illustrates a first example embodiment of a battery cell 100 with a polymer electrolyte with sulfur dioxide. The battery cell 100 includes an anodic current collector 110 on a first side and a cathodic current collector 120 on a second side of the battery cell. An anode 160 is adjacent to the anodic current collector 110 and a cathode 170 is adjacent to the cathodic current collector 120. A separating electrolyte 140 separates the anode 160 and cathode 170. In one example, the separating electrolyte 140 is a first type of sulfur dioxide polymer electrolyte. In one example, the separating electrolyte 140 is a solid inorganic electrolyte. In addition, the anode 160, the cathode 170, the separating electrolyte 140, and a second type of sulfur dioxide polymer electrolyte 150 are situated between the anodic current collector 110 and the cathodic current collector 120.

In one example, the separating electrolyte 140 is adjacent to the anode 160. In one example the anode 160 is porous, and the separating electrolyte 140 is situated inside the pores. In one example, the second type of sulfur dioxide polymer electrolyte 150 is adjacent to the cathode. In one example the cathode 170 is porous, and the second type of sulfur dioxide polymer electrolyte 150 is situated inside the pores. In one example, the cathode 170 touches the separating electrolyte 140. In another example, the cathode 170 does not touch the separating electrolyte 140. The separating electrolyte 140 may be different than the second sulfur dioxide polymer electrolyte 150 in a quality such as ionic conductivity, material properties (e.g., shear modulus) etc. Alternatively, the separating electrolyte 140 may be the same as the second sulfur dioxide polymer electrolyte 150 in composition or quality.

In one example, the anode 160 may include a solid alkali or alkaline earth metal, an alkali or alkaline earth metal alloy, an intermetallic, an intercalation compound for alkali or alkaline earth metals (e.g., carbon, silicon), etc. For example, the anode 160 may also include carbon and binders. For example, the anode 160 may be a solid alkali or alkaline earth metal.

In one example, the cathode 170 may include active materials such as intercalation compounds, metal oxides, metal hydroxides, metal cyanides, metal phosphates metal sulfides, etc. The cathode 170 may include metal chlorides, metal bromides, metal fluorides or metal iodides. In one example, the cathode 170 may contain salts. For example, the cathode 170 may also include carbon and binders. In one example, one or both of the separating electrolyte 140 and the second type of sulfur dioxide polymer electrolyte 150 may include a sulfur dioxide solvated complex of a halogen salt and a polymer. In one example, one or both of the separating electrolyte 140 and the second type of sulfur dioxide polymer electrolyte 150 may include an alkali or alkaline earth salt, sulfur dioxide and a polymer. In one example, the separating electrolyte 140 may include metal oxides, metal phosphates, metal sulfides, perovskites, and garnets.

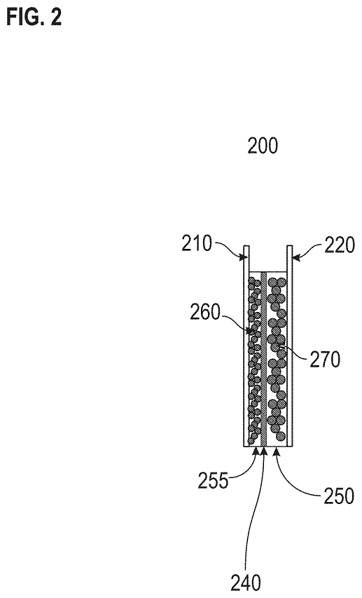

In one example, FIG. 2 illustrates a second example embodiment of a battery cell 200 with a polymer electrolyte with sulfur dioxide. The battery cell 200 includes an anodic current collector 210 on a first side and a cathodic current collector 220 on a second side of the battery cell. An anode 260 is adjacent to the anodic current collector 210 and a cathode 270 is adjacent to the cathodic current collector 220. A separating electrolyte 240 separates the anode 260 and cathode 270. In one example, the separating electrolyte 240 is a first type of sulfur dioxide polymer electrolyte. In one example, the separating electrolyte 240 is a solid inorganic electrolyte. In addition, the anode 260, the cathode 270, the separating electrolyte 240, a second type of sulfur dioxide polymer electrolyte 250, and a third type of sulfur dioxide polymer electrolyte 255 are situated between the anodic current collector 210 and the cathodic current collector 220.

In one example, the third type of sulfur dioxide polymer electrolyte 255 is situated adjacent to the anode 260. In one example, the second type of sulfur dioxide polymer electrolyte 250 is situated adjacent to the cathode 270. In one example the anode 260 is porous, and the third type of sulfur dioxide polymer electrolyte 255 is situated inside the pores. In one example the cathode 270 is porous, and the second type of sulfur dioxide polymer electrolyte 250 is situated inside the pores. In one example, the separating electrolyte 240 is situated between the second type of sulfur dioxide polymer electrolyte 250 and the third type of sulfur dioxide polymer electrolyte 255.

In one example, the anode 260 and/or the cathode 270 touches the separating electrolyte 240. In another example, one or more of the anode 260 and the cathode 270 does not touch the separating electrolyte 240. In one example, one or more of the electrolytes (i.e., the separating electrolyte 240, the second sulfur dioxide polymer electrolyte 250 and the third type of sulfur dioxide polymer electrolyte 255) may be different in a quality such as ionic conductivity, material properties (e.g., shear modulus) etc. In one example, two or more of the electrolytes (i.e., the separating electrolyte 240, the second sulfur dioxide polymer electrolyte 250 and the third sulfur dioxide polymer electrolyte 255) may be the same in composition or quality.

In one example, the anode 260 may include a solid alkali or alkaline earth metal, an alkali or alkaline earth metal alloy, an intermetallic, an intercalation compound for alkali or alkaline earth metals (e.g., carbon, silicon), etc. For example, the anode 260 may also include carbon and binders. For example, the anode 260 may be a solid alkali or alkaline earth metal.

In one example, the cathode 270 may have active materials such as intercalation compounds, metal oxides, metal hydroxides, metal cyanides, metal phosphates, metal sulfides, etc. In one example, the cathode 270 may have metal chlorides, metal bromides, metal fluorides or metal iodides. In one example, the cathode 270 may contain salts. For example, the cathode 270 may also include carbon and binders. In one example, one or more of the electrolytes (i.e., the separating electrolyte 240, the second type of sulfur dioxide polymer electrolyte 250 and third type of sulfur dioxide polymer electrolyte 255) may include a sulfur dioxide solvated complex of a halogen salt and a polymer. In one example, one or more of the electrolytes, (i.e., separating electrolyte 240, the second type of sulfur dioxide polymer electrolyte 250, and the third type of sulfur dioxide polymer electrolyte 255) may include an alkali or alkaline earth salt, sulfur dioxide and a polymer. In one example, the separating electrolyte 240 includes metal oxides, metal phosphates, metal sulfides, perovskites, and garnets.

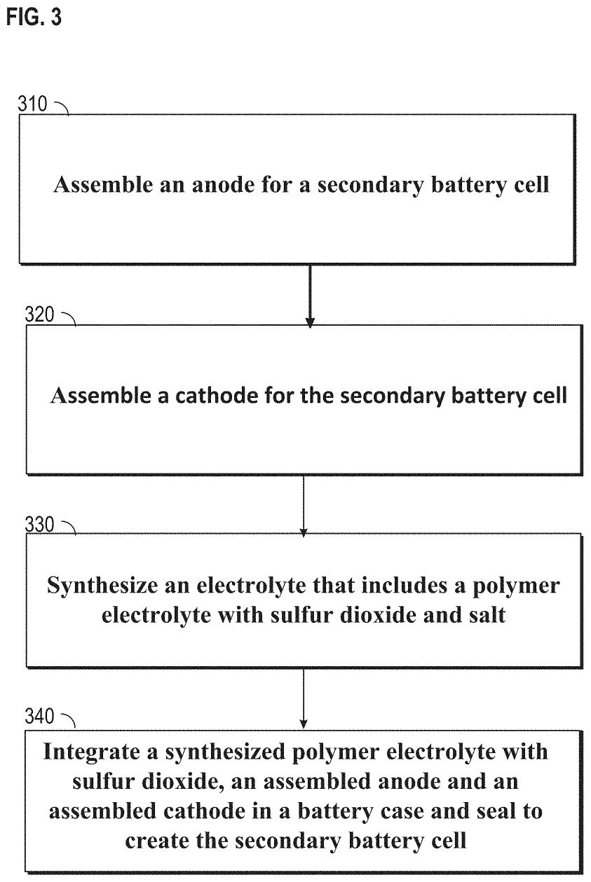

FIG. 3 illustrates an example flow diagram 300 for assembling a secondary battery cell with a sulfur dioxide polymer electrolyte. In block 310, assemble an anode for a secondary battery cell. In one example, the anode may include conductive components such as carbon. In one example, the anode may include polymer binders. For example, the anode may be interfaced with a current collector. In one example, the active material in the anode may consist of a solid alkali or alkaline earth metal, such as lithium, sodium, magnesium, potassium or calcium or an alloy of these metals. The solid metal may be handled as a foil that is laminated onto the anodic current collector, which may be solid copper. In one example, the anode may include intercalating compounds as the active material, such as carbon, silicon, aluminum, tin, metal oxides, metal cyanides or other intermetallic compound. The intercalating compounds may be mixed with carbon, binders, and applied onto the anodic current collector. The content of the active material in the anode may be 50 to 100% by weight.

In block 320, assemble a cathode for the secondary battery cell. In one example, the cathode may include conductive components such as carbon. In one example, the cathode may include polymer binders. For example, the cathode may be interfaced with a current collector. In one example, the cathode may include active material of metal chlorides, metal bromides, metal fluorides, or metal iodides. In one example, the cathode may include active material of metal oxides, metal phosphates, or metal cyanides. The active material may be mixed with carbon, binders, and applied to the cathodic current collector. The content of the active material in the cathode may be 50 to 100% by weight, but preferably 60-99% by weight. In one example, halide salts of alkali or alkaline earth metals may be included in the cathode such that the secondary battery cell is assembled in a discharged state. For example, this halide salt may be the discharge product for the battery reaction. For a secondary battery that uses sodium as the primary conducting ion with CuCl₂ active material in the cathode, the discharge product is NaCl, which may be included in the cathode during fabrication.

In block 330, synthesize an electrolyte that includes a polymer electrolyte with sulfur dioxide and salt. In one example, the synthesis of the electrolyte that includes a polymer electrolyte with sulfur dioxide and salt may take place between the assembled anode and assembled cathode. The salt may be any of, or a combination of the following halogen salts: LiAlX₄, LiGaX₄, Li₂CuX₄, Li₂NiX₄, Li₂ZnX₄, Li₂CoX₄, Li₂PdX₄, LiMgX₃, Li₂MnX₄ LiFeX₄, NaAlX₄, NaGaX₄, Na₂NiX₄, Na₂CuX₄, Na₂ZnX₄, Na₂CoX₄, Na₂PdX₄, NaMgX₃, Na₂MnX₄ NaFeX₄, KAlX₄, K₂CuX₄, K₂NiX₄, K₂ZnX₄, K₂CoX₄, K₂PdX₄, KMgX₃, K₂MnX₄, KFeX₄, CaAlX₅, CaAl₃X₈, CaCuX₄, CaZnX₄, CaMgX₄, Ca₂MnX₆ CaFeX₅, MgAlX₅, MgAl₃X₈, MgCuX₄, MgZnX₄, Mg₂MnX₆, MgFeX₅, where X is Cl (chlorine), Br (bromine), I (Iodine), or F (fluorine).

In one example, the salt will form a solvated complex with the sulfur dioxide. For example, in the sulfur dioxide solvated salt complex, the number of moles of sulfur dioxide per mole of salt, described by x in the case of NaAlCl₄ as NaAlCl₄-xSO₂, may be a value greater than 0.01 and less than 20. In one example, the sulfur dioxide solvated salt complex may range from 1% to 80% of the polymer electrolyte by weight (i.e., the remaining constituents, e.g., polymer, inorganic compounds, etc., may range from 99% to 20% by weight). In one example, a separate inorganic electrolyte may be included. Granular components of inorganic components, including inorganic electrolytes, may be mixed with the polymer electrolyte with sulfur dioxide.

For example, the inorganic components, including inorganic electrolytes, may consist of ceramics, perovskites, anti-perovskites, argyrodites, metal oxides, NASICON (i.e., sodium super ionic conductor, which comprises crystalline metal oxides that include zirconium, silicon, phosphorous, sodium and oxygen), LISICON (i.e., lithium super ionic conductor, which comprises crystalline metal oxides that include zinc, germanium, lithium and oxygen), garnets, metal hydrides, metal halides, metal nitrides, metal sulfides or metal phosphates and their derivatives and analogs.

In one example, the inorganic electrolyte may face the anode, and the polymer electrolyte may interface with the solid inorganic electrolyte and the cathode. In one example, the solid inorganic electrolyte may face the cathode, and the polymer electrolyte may interface with the solid inorganic electrolyte and the anode. In another example, the polymer electrolyte may also reside on both sides of the solid inorganic electrolyte and interface with the anode and the cathode. In one example, a premade inorganic electrolyte, in sheet or granular form, may be layered between the assembled anode and assembled cathode during the synthesis of the sulfur dioxide polymer electrolyte.

In block 340, integrate a synthesized polymer electrolyte with sulfur dioxide, an assembled anode and an assembled cathode in a battery case and seal to create the secondary battery cell. In one example, the secondary battery may be used as a rechargeable battery for energy storage and delivery.

In one aspect, reference to a secondary battery could be replaced with a primary battery. In another aspect, reference to a primary battery could be replaced with a secondary battery. One skilled in the art would understand that such replacement is within the scope and spirit of the present disclosure. In one aspect, one or more of the steps for providing a battery using polymer electrolyte in FIG. 3 may be executed by one or more processors which may include hardware, software, firmware, etc. One or more processors, for example, may be used to execute software or firmware needed to perform the steps in the flow diagram of FIG. 3. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware for making a battery using polymer electrolyte. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A battery, comprising:
an anode;
a cathode; and
an electrolyte between the anode and the cathode, wherein the electrolyte comprises at least one polymer electrolyte that includes sulfur dioxide.

2. The battery of claim 1, wherein the polymer electrolyte includes a polymer, sulfur dioxide and salt.

3. The battery of claim 2, wherein the polymer electrolyte includes a polymer, sulfur dioxide and metal halide.

4. The battery of claim 2, wherein the cathode includes metal salt.

5. The battery of claim 2, wherein the cathode includes a compound that can intercalate metals.

6. The battery of claim 4, wherein the anode comprises an alkali or an alkaline earth metal.

7. The battery of claim 5, wherein the anode comprises an alkali or an alkaline earth metal.

8. The battery of claim 6, wherein the electrolyte includes an inorganic metal-containing compound.

9. The battery of claim 7, wherein the electrolyte includes an inorganic metal-containing compound.

10. A method comprising:
a) assembling an anode for a battery cell;
b) assembling a cathode for the battery cell;
c) synthesizing an electrolyte that comprises at least one polymer electrolyte with sulfur dioxide; and
d) integrating the assembled anode, the assembled cathode, and synthesized electrolyte to create a battery.

11. The method of claim 10, wherein the polymer electrolyte includes a polymer, sulfur dioxide and a salt.

12. The method of claim 11, wherein the polymer electrolyte includes a polymer, sulfur dioxide and a metal halide.

13. The method of claim 11, wherein the cathode includes a metal salt.

14. The method of claim 11, wherein the cathode includes a compound that can intercalate metals.

15. The method of claim 13, wherein the anode comprises an alkali or an alkaline earth metal.

16. The method of claim 14, wherein the anode comprises an alkali or an alkaline earth metal.

17. The method of claim 15, wherein the electrolyte includes an inorganic metal-containing compound.

18. The method of claim 16, wherein the electrolyte includes an inorganic metal-containing compound.
